(19) United States
(12) Patent Application Publication
(10) Pub. No.: US 2014/0153580 A1
(43) Pub. Date: Jun. 5, 2014

(54) REFERENCE ENCODING AND DECODING FOR IMPROVING NETWORK HEADER COMPRESSION THROUGHPUT FOR NOISY CHANNELS

(71) Applicant: Comtech EF Data Corp., Tempe, AZ (US)

(72) Inventors: Lakshmana Chintada, Chandler, AZ (US); Jason McCollum, Mesa, AZ (US)

(73) Assignee: Comtech EF Data Corp., Tempe, AZ (US)

(21) Appl. No.: 14/177,556

(22) Filed: Feb. 11, 2014

Related U.S. Application Data
(60) Provisional application No. 61/765,373, filed on Feb. 15, 2013.

(51) Int. Cl. H04L 29/06

(52) U.S. Cl. CPC H04L 69/04; H04L 69/18; H04L 69/22
USPC 370/392

(57) ABSTRACT

A method of reducing packet loss resulting from header compression during data transmission comprising of calculating, by a transmitter, the difference between one or more delta fields of each packet among a plurality of packets and a base frame of data wherein for at least a portion of the packets, the base frame is a packet other than a packet immediately preceding the packet for which the difference is calculated, encoding the difference and compressing the plurality of packets using the transmitter; transmitting, using the transmitter, the plurality of compressed packets and an uncompressed full-header packet through a communications channel to a receiver, receiving the plurality of compressed packets and the uncompressed full-header packet by the receiver, and decompressing, by the receiver, the plurality of compressed packets using the difference between the one or more delta fields of each packet among the plurality of compressed packets and the base frame.

### CROSS REFERENCE TO RELATED APPLICATIONS

This document claims the benefit of the filing date of U.S. Provisional Patent Application No. 61/765,373, entitled “Reference Encoding and Decoding for Improving Network Header Compression Throughput for Noisy Channels” to Lakshmana Chintada, et al., which was filed on Feb. 15, 2013,the disclosure of which is hereby incorporated entirely by reference herein.

### BACKGROUND

1. Technical Field

Aspects of this document relate generally to telecommunication systems and techniques for transmitting data across a telecommunication channel.

2. Background Art

Network headers, such as Ethernet, IP, TCP, and UDP, can add significant overhead to a network packet, particularly packets with a small amount of data. A method for compressing TCP/IP headers to reduce overhead for low-speed communication channels currently exists in the art that works on communication links with a high error rate and on uni-directional links that cannot receive feedback from the remote receiver, such as communication channels commonly associated with satellite networks.

In the existing art, header compression relies on the receiver first seeing a full network header. Then from this header, the sender transmits delta changes from each sent packet. Thus, if packet n is a packet with a full header, then packet n+1 contains delta changes from n and packet n+2 contains delta changes from packet n+1, and so on.

In low reliability, uni-directional (simplex) links, a full-header refresh is used to re-synchronize communications between the sender and receiver in the event that the receiver misses data. If the receiver misses a packet for any reason, such as the packet is corrupted during transmission, then the receiver becomes out of sync with the sender. The sender continues computing deltas from a packet that the receiver never received, so the receiver cannot reconstruct the packet. The receiver, however, does not know that it missed a packet, so it rebuilds incorrect packets. The TCP endpoint is the network device that detects the error, and requests retransmission of the bad packets from the sending endpoint. Therefore, to reduce the impact of missed packets, the transmitter periodically sends full headers so that the receiver can re-synchronize its delta computations.

Therefore, in the current art, if the receiver misses a packet, then all following packets are incorrectly reconstructed and will be rejected by the receiving TCP endpoint until the sender provides a full-header packet.

So as to reduce the length and complexity of the detailed description and fully establish the state of the current art, Applicant hereby incorporates the following documents by reference in their entirety:

Jacobson, Van. “Compressing TCP/IP Headers for Low-Speed Serial Links” (RFC 1144); February 1990; p. 1-46. (available at http://tools.ietf.org/html/rfc1144.html.)

U.S. Pat. No. 7,450,586 to Hector Davila, et al., entitled “Network Header Compression Arrangement, issued Nov. 11, 2008.

### SUMMARY

According to a first aspect, a method of reducing packet loss directly caused by header compression during data transmission, the method comprising, calculating, by a transmitter, a difference between one or more fields of at least one of a plurality of following packets, and at least one of a base frame of data and a full-header packet, wherein for at least a portion of the plurality of following packets for which the difference is calculated, the at least one of the base frame of data and the full-header packet is a packet other than a packet immediately preceding the following packet, encoding the difference and compressing the plurality of packets using the transmitter, transmitting, using the transmitter, the plurality of compressed packets and an uncompressed full-header packet through a communications channel to a receiver, receiving the plurality of compressed packets and the uncompressed full-header packet by the receiver, and decompressing, by the receiver, the plurality of compressed packets using the difference between the one or more delta fields of each packet among the plurality of compressed packets and the base frame.

Particular implementations and embodiments may comprise one or more of the following. The transmitter and receiver may use Transmission Control Protocol (TCP). The one or more delta fields of the plurality of compressed packets may have a same number of bits. The one or more delta fields of the plurality of compressed packets may have a different number of bits. The one or more delta fields may comprise at least one of a TCP sequence number, a TCP window, and a TCP acknowledgment number. The base frame may comprise the uncompressed full-header packet. Each compressed packet may comprise a compressed header that comprises one or more delta fields of a last-transmitted full-header packet and the compressed packet. The compressed header may comprise a bit mask that identifies the one or more delta fields and indicates a change in the one or more delta fields. Calculating, by the transmitter, a difference between a TCP sequence number, a TCP window, and a TCP acknowledgment number of a full-header packet and a compressed packet and encoding within a bit mask of the compressed packet a result when the difference is non-zero.

According to another aspect, a method of reducing packet loss resulting from header compression during data transmission may comprise calculating, by a transmitter, a difference between one or more delta fields of a full-header packet and a compressed packet; encoding, using the transmitter, the difference between the one or more delta fields of the full-header packet and the compressed packet when the difference is non-zero, and embedding, using the transmitter, the encoded non-zero difference within the compressed packet to form a compressed header for transmission through a communications channel.

Particular implementations and embodiments may comprise one or more of the following. The transmitter and a receiver may use Transmission Control Protocol (TCP). The one or more delta fields of the plurality of compressed packets may have a same number of bits. The one or more delta fields of the plurality of compressed packets may have a different number of bits. The one or more delta fields may comprise at least one of a TCP sequence number, a TCP window, and a TCP acknowledgment number. The compressed header may comprise a bit mask that identifies the one or more delta fields and indicates a change in the one or more delta fields. Calculating, by the transmitter, a difference between a TCP sequence number, a TCP window, and a TCP acknowledgment number of the full-header packet and a compressed packet and encoding within a bit mask of the compressed packet a result when the difference is non-zero.

According to another aspect, a method of reducing packet loss resulting from header compression during data transmission may comprise receiving, by a receiver, a plurality of compressed packets and a full-header packet transmitted through a communications channel; and decompressing, by the receiver, the plurality of compressed packets using a difference between one or more delta fields of each of the compressed packets and one or more delta fields of base frame of data received, wherein for at least a portion of the compressed packets, the base frame is a packet other than a packet immediately preceding the compressed packet.

Particular implementations and embodiments may comprise one or more of the following. A transmitter and the receiver may use Transmission Control Protocol (TCP). The one or more delta fields of the plurality of compressed packets may have a same number of bits. The one or more delta fields of the plurality of compressed packets may have a different number of bits. The one or more delta fields may comprise at least one of a TCP sequence number, a TCP window, and a TCP acknowledgment number. The base frame may comprise the full-header packet. Each of the compressed packets may further comprise a compressed header comprising a bit mask that identifies the one or more delta fields and indicates a change in the one or more delta fields.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶6. Thus, the use of the words “function,” “means” or “step” in the Description , Drawings, or Claims is not intended to somehow indicate a desire to invoke the special provisions of 35 U.S.C. §112, ¶6, to define the invention. To the contrary, if the provisions of 35 U.S.C. §112, ¶6 are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 depicts an example of a TCP packet header as known in the prior art.

FIG. 2 depicts a prior art method of transmitting data across a telecommunications channel with packet losses.

FIG. 3 depicts an implementation of a method of decompressing received packets after loss of a packet.

FIG. 4 is a block diagram of a method of decompressing received packets without packet loss after an error.

### DESCRIPTION

This disclosure, its aspects and implementations, are not limited to the specific components, TCP fields, delta field sizes, sender and receiver number or configuration, or specific packet from which to compute deltas, or methods disclosed herein. Many configurations are known in the art for network header compression. Accordingly, although particular implementations are disclosed, such implementations and implementing components may be comprised of any components, models, versions, quantities, and/or the like as is known in the art for such systems and implementing components, consistent with the intended operation.

This disclosure relates to, but is not limited to, improving unreliable network communication links using a network component that implements network header compression. Particular implementations described herein are and may use, but are not limited to, wireless satellite communication devices that utilize microprocessors, field-programmable gate arrays (FPGAs), or digital signal processors. While some implementations of the network header-compression techniques disclosed herein may be specifically employed in satellite communications systems, as will be clear to those of ordinary skill in the art from this disclosure, the principles and aspects disclosed herein may readily be applied to any network communications system, such as a cellular phone network or terrestrial radio-based installations without undue experimentation. Particular implementations of the disclosed method can be implemented either in software or hardware using conventional implementation methods known in the art with knowledge of this disclosure.

The methods described may provide the ability for someone skilled in the art, e.g., a satellite operator, a network administrator, federal or state agency, private or commercial operator, to improve throughput, lower application latency and response time by reducing network retransmissions, and better utilize bandwidth of an unreliable communications link.

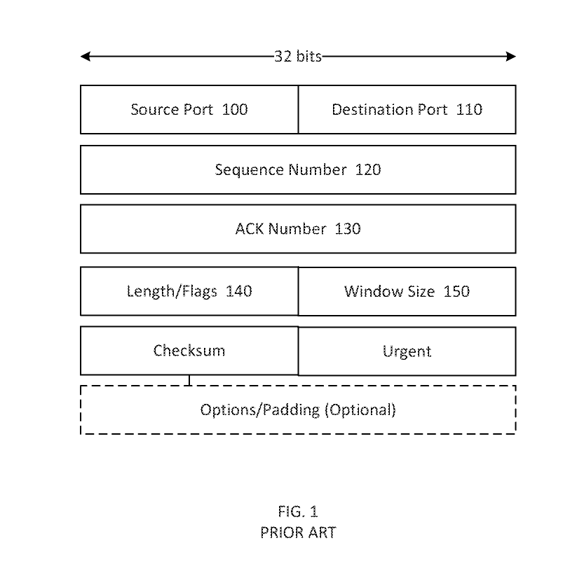

FIG. 1 provides an example of a TCP packet header as known in the prior art. As one of ordinary skill in the art would be aware, the various fields such as for example, source port 100, destination port 110, sequence number 120, ACK number 130, length/flags 140, and window size 150 may be omitted or reduced in size during compression and then computed by a remote decompressor when decompressing the packet. The packet header here is shown as having a size of at least 20 bytes, but one of ordinary skill in the art would be aware that any other appropriate packet header size may also be used depending upon the application.

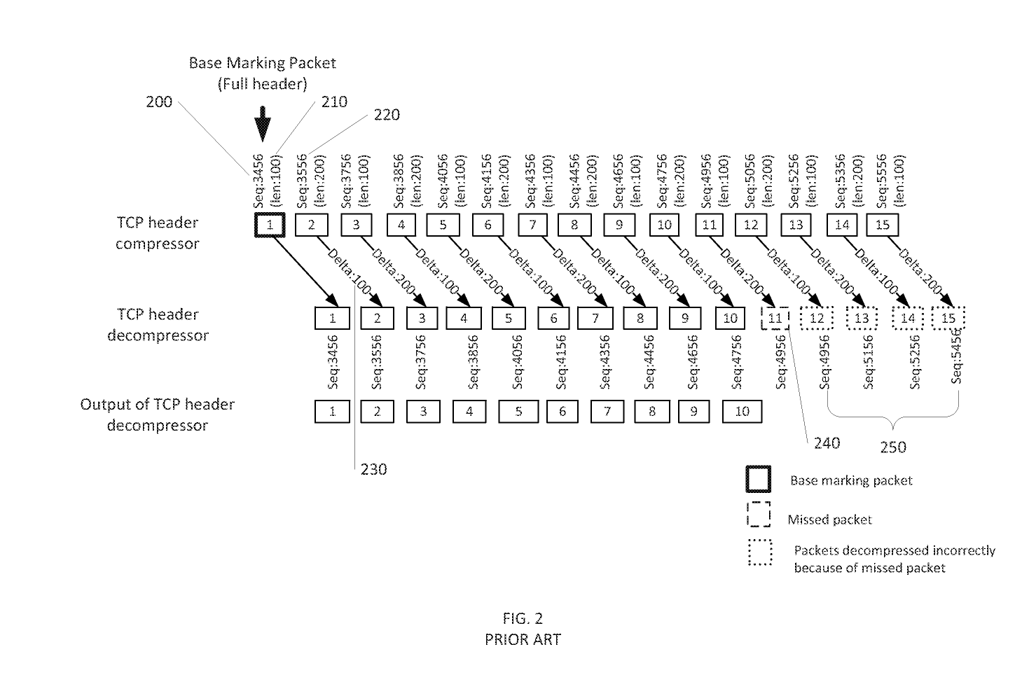

This disclosure provides implementations of a method for reducing the number of lost packets and/or the amount of data bytes lost from a base packet during network header compression encoding process. In the prior art, a lost packet results in all future compressed packets being lost until the receiver sees a full header. FIG. 2 provides an example the present methodology used in the prior art and illustrates the behavior of the system when an error occurs. As shown, a packet's sequence number 200 plus the packet's length 210 provides the sequence number of the following packet 220. Thus, the compressed sequence number is a delta 230 from the previous packet's sequence number 200, an error resulting in a lost packet 240 subsequently results in corruption and loss of all future packets 250 until the next full header refresh occurs. Because of this, network header compression adds significant retransmission overhead on a link with low reliability.

Implementations of the disclosed methods are based on computing the delta from a specific reference packet, not from the previous packet. In one particular implementation, the network devices all agree that a specific packet is used as the delta reference, such as for example, the last full-header packet. Another particular implementation may have senders and receivers negotiate the delta reference packet out of band, such as by using a TCP option field. For simplicity and as an example only, hereafter we describe the scenario in which one sender and one receiver are each computing deltas from the last full-header packet sent or received, although any other base reference packet may also be used.

The improvement introduced by implementations of the disclosed method is measured by the number of discarded packets caused by a missed packet within the full-header refresh interval. If the receiver misses a delta packet, the receiver can still reconstruct all following packets and therefore loses only a single packet. If the full header reference packet is lost or corrupted, this method performs no better and no worse than existing methodologies for that particular refresh interval.

Delta fields are fields that can change from packet to packet in a TCP stream. The delta requires fewer bytes to express than the full header, so delta fields can be anywhere from 1 byte to the original size of the uncompressed field.

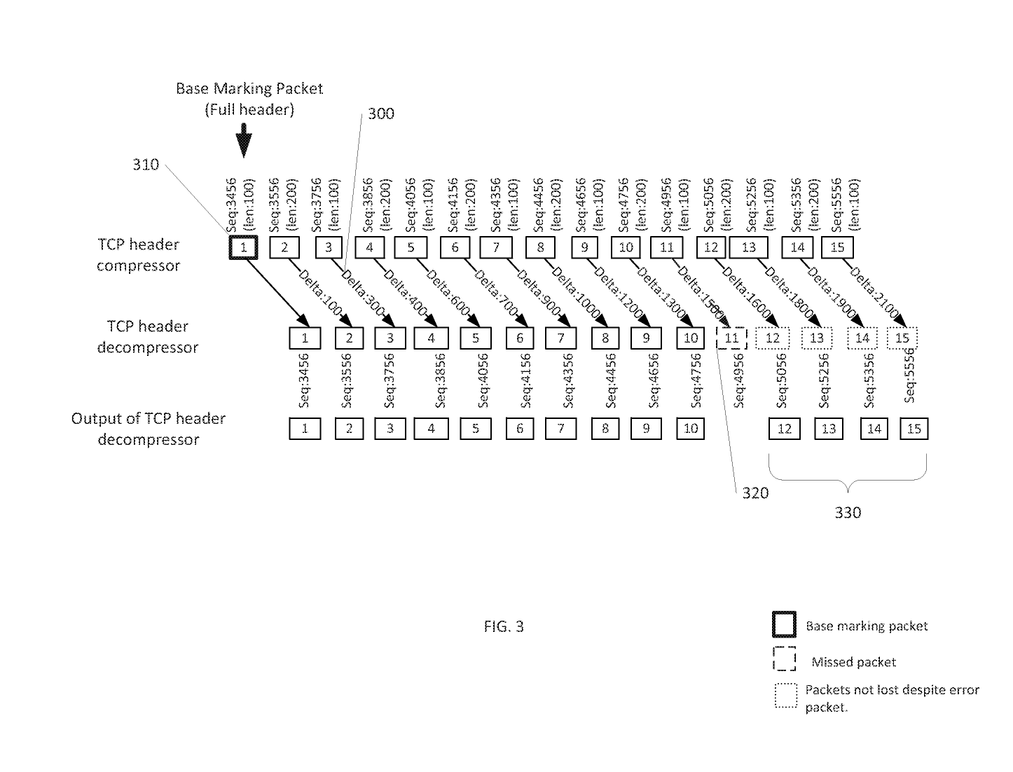

Thus, to prevent one lost or corrupted packet from impacting all following packets until a full refresh, implementations of the disclosed method compute the delta from a specific packet, such as the last full-header packet, instead of the previous packet. As shown in FIG. 3, the sequence number delta 300 of a packet is computed relative to the full header base marking packet 310 rather than the packet just prior to the packet for which the sequence number delta is computed. Thus, when an error occurs and a received packet is unrecoverable 320 the TCP header decompressor is still able to recover the packets received subsequent to the error 330 and prior to the next full header refresh.

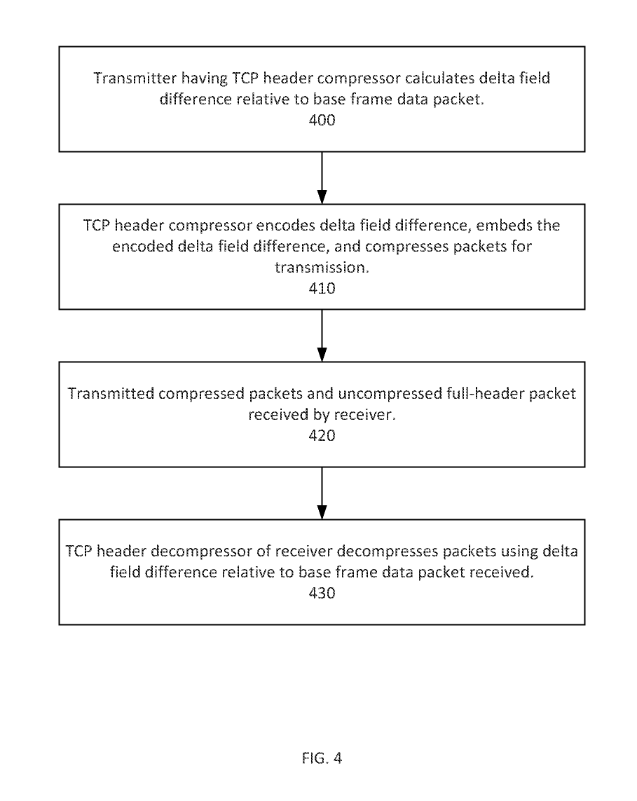

FIG. 4 provides a block diagram of an exemplary implementation of a method of encoding and decoding with reduced packet loss. A transmitter having a TCP header compressor calculates a delta field difference of each packet relative to a base frame of data rather than from the packet immediately preceding the packet for which the difference is being calculated 400. The TCP header compressor encodes the delta field difference and embeds it in the compressed packets 410, which are transmitted to a receiver. The receiver receives the compressed packets along with an uncompressed full-header packet 420. A TCP header decompressor of the receiver then decompresses the packets using the delta field difference relative to the base frame packet received 430.

Some implementations of the disclosed method assume that the size of compressed fields is fixed, and both the sender and receiver are aware of the fixed size. Other implementations may negotiate field sizes out of band, or use an encoding technique to represent a larger field size dynamically.

A particular implementation can use fixed-size delta fields, such as for example, delta fields of 2 bytes long. When a field is a fixed size, if a computed delta cannot fit into the range, the sender transmits a full-header packet.

In some implementations, the field size can be negotiated out of band or the size may be variably encoded. As an example, and not by way of limitation, when a field is variably sized, the compressor first assumes that the computed delta will be 1 through 255 bytes. If that is the case, then the field is encoded as one byte. If the delta does not fit in that range, then a 3-byte quantity is sent where the first byte is always 00. The remaining 2 bytes contain the delta value. Different field sizes can be encoded by similarly reserving other values of the first byte to have a special meaning similar to 00 above. For example, the numbers 255, 254, 253, could each be used to indicate a different variable-sized encoding.

Delta fields may include, but are not limited to, the TCP Sequence Number, TCP Window, and TCP Acknowledgement Number. All of these fields can be encoded at any size according to the prior art, but for simplicity, in some implementations, it may be preferable to assign a fixed delta field size of 2 bytes. This size gives a delta range of 0 through 65535 bytes; however one of ordinary skill in the art would recognize that any appropriate delta field size may also be used.

The last full-header packet is saved in memory by both the sender and receiver. The transmitter sends full-header packets both when performing a refresh, and whenever a packet is not compressible according to the rules of the prior art methodologies. For each compressible packet, the transmitter computes the delta of the last transmitted full-header packet and the current packet. The result gives a compressed header that is sent to the receiver.

The compressed header includes a bit mask indicating what delta fields are included and have changed. For example, for TCP it would include W, A, and S bits. These bits indicate the presence or absence of a delta for the Window Size field, ACK number field, and Sequence Number field, respectively. The difference between the current packet and full-header packet's window field is computed and, if non-zero, is encoded and the W bit is set in the compressed packet's change mask.

The difference between the current packet and full-header packet's ACK field is computed. If the result is greater than or equal to 0 or less than 2¹⁶ (for a fixed 2-byte field), the result is the delta and the A bit is set in the change mask. The sender may use additional encoding rules to handle ranges larger than 2¹⁶ if desired. The difference between the current packet and full-header packet's Sequence Number field is then computed. If the result is greater than or equal to 0 or less than 2¹⁶ (for a fixed 2-byte field), the result is the delta and the S bit is set in the change mask. The sender may use additional encoding rules to handle ranges larger than 2¹⁶ if desired. If any delta computation produces a result that cannot be encoded in fewer bytes than the field size, a full-header packet is sent instead.

Particular implementations may compute deltas for other fields, whether standard TCP or application specific. The sender may compute special-case encodings and send the compressed header to a receiver. The receiver receives either an uncompressed full-header packet, or a compressed delta packet. When the packet is a full-header packet, the receiver stores it in memory and uses it to compute all deltas until the next full-header packet. If the packet is a delta packet, the receiver adds the deltas for all fields indicated in the packet's change mask (e.g., W, A, or S bits).

Some implementations of the disclosed method may comprise decoding a base-encoded packet while some implementations may comprise encoding a TCP sequence number, TCP window size, and/or a TCP ACK number in a base packet.

Implementations of the disclosed methods may provide the advantages of improving the data throughput between a single error frame to full-header packet, in a noisy communication environment, and/or for channels with a long propagation delay. Additionally, implementations of the disclosed method may improve header compression throughput using one or more refresh rate techniques regardless of whether a return channel is available.

The implementations listed here, and many others, will become readily apparent from this disclosure. From this, those of ordinary skill in the art will readily understand the versatility with which this disclosure may be applied. In places where the description above refers to particular implementations of telecommunication systems and techniques for transmitting data across a telecommunication channel, it should be readily apparent that a number of modifications may be made without departing from the spirit thereof and that these implementations may be applied to other to telecommunication systems and techniques for transmitting data across a telecommunication channel.

1. A method of reducing packet loss directly caused by header compression during data transmission, the method comprising:
calculating, by a transmitter, a difference between one or more fields of at least one of a plurality of following packets, and at least one of a base frame of data and a full-header packet, wherein for at least a portion of the plurality of following packets for which the difference is calculated, the at least one of the base frame of data and the full-header packet is a packet other than a packet immediately preceding the following packet;
encoding the difference and compressing the plurality of packets using the transmitter;
transmitting, using the transmitter, the plurality of compressed packets and an uncompressed full-header packet through a communications channel to a receiver;
receiving the plurality of compressed packets and the uncompressed full-header packet by the receiver; and
decompressing, by the receiver, the plurality of compressed packets using the difference between the one or more delta fields of each packet among the plurality of compressed packets and the base frame.

2. The method of claim 1, wherein transmitter and receiver use Transmission Control Protocol (TCP).

3. The method of claim 1, wherein the one or more delta fields of the plurality of compressed packets have a same number of bits.

4. The method of claim 1, wherein the one or more delta fields of the plurality of compressed packets have a different number of bits.

5. The method of claim 2, wherein the one or more delta fields comprise at least one of a TCP sequence number, a TCP window, and a TCP acknowledgment number.

6. The method of claim 1, wherein the base frame comprises the uncompressed full-header packet.

7. The method of claim 1, wherein each compressed packet comprises a compressed header that comprises one or more delta fields of a last-transmitted full-header packet and the compressed packet.

8. The method of claim 7, wherein the compressed header comprises a bit mask that identifies the one or more delta fields and indicates a change in the one or more delta fields.

9. The method of claim 5, further comprising calculating, by the transmitter, a difference between a TCP sequence number, a TCP window, and a TCP acknowledgment number of a full-header packet and a compressed packet and encoding within a bit mask of the compressed packet a result when the difference is non-zero.

10. A method of reducing packet loss resulting from header compression during data transmission comprising:
calculating, by a transmitter, a difference between one or more delta fields of a full-header packet and a compressed packet;
encoding, using the transmitter, the difference between the one or more delta fields of the full-header packet and the compressed packet when the difference is non-zero; and
embedding, using the transmitter, the encoded non-zero difference within the compressed packet to form a compressed header for transmission through a communications channel.

11. The method of claim 10, wherein the transmitter and a receiver use Transmission Control Protocol (TCP).

12. The method of claim 10, wherein the one or more delta fields of the plurality of compressed packets have a same number of bits.

13. The method of claim 10, wherein the one or more delta fields of the plurality of compressed packets have a different number of bits.

14. The method of claim 11, wherein the one or more delta fields comprise at least one of a TCP sequence number, a TCP window, and a TCP acknowledgment number.

15. The method of claim 10, wherein the compressed header comprises a bit mask that identifies the one or more delta fields and indicates a change in the one or more delta fields.

16. The method of claim 14, further comprising calculating, by the transmitter, a difference between a TCP sequence number, a TCP window, and a TCP acknowledgment number of the full-header packet and a compressed packet and encoding within a bit mask of the compressed packet a result when the difference is non-zero.

17. A method of reducing packet loss resulting from header compression during data transmission comprising:
receiving, by a receiver, a plurality of compressed packets and a full-header packet transmitted through a communications channel; and
decompressing, by the receiver, the plurality of compressed packets using a difference between one or more delta fields of each of the compressed packets and one or more delta fields of base frame of data received, wherein for at least a portion of the compressed packets, the base frame is a packet other than a packet immediately preceding the compressed packet.

18. The method of claim 17, wherein a transmitter and the receiver use Transmission Control Protocol (TCP).

19. The method of claim 17, wherein the one or more delta fields of the plurality of compressed packets have a same number of bits.

20. The method of claim 17, wherein the one or more delta fields of the plurality of compressed packets have a different number of bits.

21. The method of claim 18, wherein the one or more delta fields comprise at least one of a TCP sequence number, a TCP window, and a TCP acknowledgment number.

22. The method of claim 17, wherein the base frame comprises the full-header packet.

23. The method of claim 17, wherein each of the compressed packets further comprises a compressed header comprising a bit mask that identifies the one or more delta fields and indicates a change in the one or more delta fields.
